(19) United States
(12) Patent Application Publication
(10) Pub. No.: US 2014/0356573 A1
(43) Pub. Date: Dec. 4, 2014

(54) Punching Device, Punching Assembly, Punching Knife, Paper Sheet, and a Method for Providing Thereof

(71) Applicant: Innobind Holding B.V., Amsterdam (NL)

(72) Inventor: Paul Gokkel, Bloemendaal (NL)

(73) Assignee: Innobind Holding B.V., Amsterdam (NL)

(21) Appl. No.: 14/372,145

(22) PCT Filed: Jan. 14, 2013
(86) PCT No.: PCT/NL2013/050019

§ 371 Date: Jul. 14, 2014

(30) Foreign Application Priority Data
Jan. 12, 2012 (NL) 2008113

(51) Int. Cl. B31F 5/02; B42F 3/00; B26F 1/02

(52) U.S. Cl. CPC B31F 5/027; B26F 1/02; B42F 3/003
USPC 428/131; 83/467.1; 83/30

(57) ABSTRACT

The present invention relates to a punch device for punching a stack comprising at least one sheet of paper, comprising: —a frame; —at least one guide element for guiding the stack to a punching position; —at least one punch element for co-action with a respective punch plate element and which is mounted movably on the frame, wherein the punch element is movable reciprocally from a rest position along a punching path; and —an operating element for moving the punch element selectively along the punching path, —wherein the punch device is adapted to punch at least one recess in an cutting face of the stack.

The present invention relates to a punch device for punching at least one sheet of paper.

The present invention further relates to a punch blade for punching paper.

The present invention likewise relates to a punch assembly.

The present invention further relates to a sheet of paper produced with use of a punch device according to the invention, or an assembly according to the invention, and a method for manufacture thereof.

Known per se is a binding system wherein a stack comprising at least one sheet of paper can be coupled to another stack comprising at least one sheet of paper. The stacks are connected to each other by means of tabs provided on at least one edge of the paper. The tabs of the one stack are offset relative to the tabs of the other stack, so that the tabs can engage each other in order to effect the coupling.

An advantage of such a system is that a book with a number of sheets can be easily produced. A drawback of sheets with such tabs is that, when the tabs are present in the paper prior to printing, it is necessary to determine for each page the position it must have in the book prior to printing, wherein the infeed direction of the paper must be determined.

The present invention has for its object to obviate or at least reduce such a drawback of the known art. The invention provides for this purpose a punch device for punching a stack comprising at least one sheet of paper, comprising:
a frame;
at least one guide element for guiding the stack to a punching position;
at least one punch element for co-action with a respective punch plate element and which is mounted movably on the frame, wherein the punch element is movable reciprocally from a rest position along a punching path; and
an operating element for moving the punch element selectively along the punching path,
wherein the punch device is adapted to punch at least one recess in an edge of the stack.

An advantage of the invention is that a user of the punch device is able to punch the paper him/herself, whereby the position of the tabs is determined after printing, preferably even after the sheets of the book have been placed in the stacking sequence. The invention allows the user to print the paper or to perform any other operations without problem before the paper is provided with the tabs. Using the present invention it is possible to print a stack of paper, and then divide it into two stacks. After division of the stack into two stacks, the tabs can be arranged in the edge of the paper, wherein integration of the tabs differs for each stack. A user need not therefore work out beforehand which page is printed on which sheet of paper, since the orientation during printing of the paper is important for the orientation of the tabs, this in turn being important for connecting of the stacks of paper.

A function of the guide element is to align the paper so that the orientations of the tabs of the two stacks fit together properly. Throughfeed problems with the paper with protruding tabs during printing in the printer are also prevented with the present invention.

The invention has diverse preferred embodiments which will become apparent from the description below of several such embodiments. The advantageous inventive features of the invention in all its aspects, including the measures defined in the dependent claims, are by no means limited to the considerations stated above and/or below.

A first preferred embodiment of the punch device has the feature that a second guide element is provided on the frame which is preferably located a distance from the guide element such that the stack is movable between the guide element and the second guide element. An advantage of this embodiment is that a stack is aligned in each case relative to the same points, i.e. the guide element and the second guide element. This prevents inaccuracies.

It is advantageous here for more than one punch element to be mounted on the frame, preferably between 1 and 10 punch elements, more preferably between 2 and 7, more preferably between 3 and 6, more preferably 5 punch elements. A result of this embodiment is that recesses can be arranged in an edge of a stack along the whole length thereof. A user need therefore perform the operations only once in order to arrange the recesses, and can then connect different stacks to each other. An efficient device is in this way provided.

A further preferred embodiment of the punch device according to the invention has the feature that the punch elements are movable simultaneously between the rest position and the punching position. It is advantageous here, when the punch elements are in the rest position, that undersides of the punch elements form substantially a V-shape or reverse V-shape. An advantage hereof is that the user can arrange the recesses in the edge of the stack with a single operation without having to exert a great deal of force for this purpose. Owing to the V-shape or reverse V-shape not all punch elements make simultaneous contact with the stack, but the punch elements make successive contact with the stack. That is, in the case where there are for instance five punch elements available, a first punch element will first make contact with the stack, subsequently a second and third punch element and then a fourth and fifth punch element. A result hereof is that the force exerted by the user is concentrated at a limited number of contact points between the stack and the punch elements.

A further preferred embodiment of the punch device according to the invention has the feature that the punch element is a punch blade for punching the stack, the punch blade comprising:
an elongate body with a peripheral form corresponding to a desired form of a recess to be punched, wherein at least one outer end of the elongate body is sharpened for the purpose of punching the stack. Punching by means of exerting pressure on a stack while using a sharpened object has the advantage that a punched recess has a substantially neat shape following punching. A recess is in this way provided which has a neat appearance, so that the punched stack can be utilized for many purposes.

A further preferred embodiment of the punch device has the feature that the elongate body is at least partially hollow. It is advantageous here for the punch blade to be completely hollow in a cutting face thereof or to comprise a rectangular or oval recess. A result of varying the cutting face of the punch blade is that different sharpnesses are obtained on the cutting face. The sharpnesses of the cutting face affect the quality of the punching. It is possible to envisage determined areas/transitions between areas being more difficult to punch than for instance straight lines, whereby a sharper cutting face is required for the more difficult areas than for instance for the straight lines. The strength of the punch blade is also influenced in this way.

A further preferred embodiment of the punch device has the feature that at least one side of the punch element has a shape selected from the group comprising: a semicircular shape, an oval shape, and/or a shape made up of two quarters of a circle with a straight line segment therebetween. It is advantageous here that an opposite side has a similar shape to the at least one side. The recesses/tabs formed in an edge of the stack, or the paper, have the purpose of coupling to another stack with similar recesses/tabs. The shape of the recesses/tabs affects the force which has to be exerted to bring about the coupling, just as the size of the recesses/tabs is likewise important. By varying the shape of the recesses/tabs it is possible to make allowance for the specific situation in which the stack is going to be used.

A shape made up of two quarters of a circle with a straight line segment therebetween is particularly recommended. This shape is simple to manufacture and the manufactured recesses/tabs can be mutually coupled without too much effort.

A preferred embodiment of the punch device according to the invention has the feature that the punch element co-acts with a housing, wherein the punch element and the housing form a punch assembly. An advantage of this embodiment is that the punch element is shielded by the housing from the surrounding area and/or therefore from ambient influences. The punch element is hereby less susceptible to the ambient influences and will therefore incur no, or at least less, damage. The lifespan of the punch element is hereby increased.

A further preferred embodiment of the punch device has the feature that the housing comprises:
a punch plate element adapted to support the stack during a punching operation; and
a guide for guiding the punch blade, wherein the guide is arranged on the punch plate element substantially transversely of the punch plate element. Supporting of the stack has the advantage that a force is exerted on the stack which is opposed to the force exerted by the punch element. As a result the punching of the stack is made easier since the user of the punch device need exert less force in order to punch the stack.

The guide has the advantage that the punch element always strikes the punch plate element at the same location, so that the punching operation can be repeated on different stacks with substantially the same result in each case. An advantage of this embodiment is that individually produced coupled stacks are substantially the same as each other.

It is advantageous here that the guide at least partially encloses the punch element. The punch element in this way acquires as it were a dual function, i.e. that of punching the stack and also that of guiding itself along the punching path. An advantage of this embodiment is that the punch element is in itself sufficient for the purpose of the punching and the guiding of the punch element. This facilitates manufacture of the punch element since an additional guide need not be provided.

It is advantageous here for a passage for the punch element to be provided in the punch plate element. Providing a passage in the punch plate element makes it possible for the punch element to as it were move through the stack. This is brought about by the shear forces created by pressing the punch element against the stack and an opposed force of the punch plate element. A result of these shear forces is that punching of the stack is made even easier.

It is advantageous here for the punch element and/or the punch assembly to be mounted releasably on the frame. An advantage of this embodiment is that the alignment of the punch element/punch blade, particularly the alignment of the punch element relative to the housing of the punch assembly, can be performed per punch element. A result hereof is that it is easier to achieve a desired alignment compared to the prior art.

A further aspect of the invention relates to a punch blade. The punch blade has at least the advantages as stated above in relation to the punch blade of the punch device.

A further aspect of the invention relates to a punch assembly. The punch assembly has at least the advantages as stated above in relation to the punch assembly of the punch device.

It is further advantageous for mounting means to be provided on the punch assembly. This achieves that the punch assembly can be fixed relative to the punch device and is also releasable.

A further aspect of the invention relates to a sheet of paper produced with use of a punch device according to the invention. A sheet of paper produced with use of the punch device according to the invention can be coupled to another sheet of paper produced in the same way, whereby the sheet of paper has at least the advantages as stated above.

A first preferred embodiment of the sheet of paper has the feature that the sheet of paper comprises tabs on at least one edge of the sheet of paper, which tabs each comprise at least one cheek and/or at least one flange. An advantage of this embodiment is that the sheet of paper can in this way be coupled to another sheet of paper of corresponding form. Sheets of paper can hereby be coupled to each other as described above.

It is advantageous here that a shape of the at least one cheek and/or flange is selected from the group comprising: a semicircular shape, an oval shape, and/or a shape made up of two quarters of a circle with a straight line segment therebetween. The recesses/tabs formed in an edge of the stack, or the paper, have the purpose of coupling to another stack with similar recesses/tabs. The shape of the recesses/tabs affects the force which has to be exerted to bring about the coupling, just as the size of the recesses/tabs is likewise important. By varying the shape of the recesses/tabs it is possible to make allowance for the specific situation in which the stack is going to be used.

A shape made up of two quarters of a circle with a straight line segment therebetween is particularly recommended. This shape is simple to manufacture and the manufactured recesses/tabs can be coupled to each other without too much effort.

A further aspect of the invention relates to a method for producing a sheet of paper according to the invention, the method comprising steps for:
providing at least one sheet of paper;
placing the at least one sheet of paper in a guide element;
guiding the at least one sheet of paper to a punching position;
punching at least one recess into an edge of the sheet of paper; and
taking the sheet of paper out of the guide element. The method has at least the same advantages as stated above in relation to the punch device, punch blade, punch assembly or the produced sheet of paper.

Further advantages, features and details of the present invention are elucidated on the basis of a number of embodiments with reference to the accompanying figures, in which:

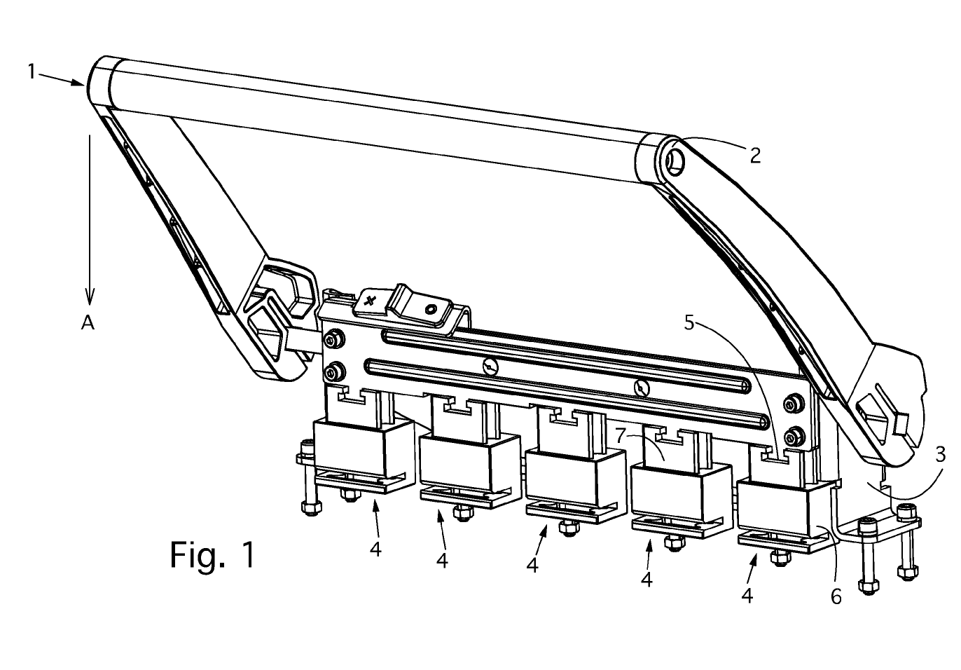

FIG. 1 is a schematic cut-away view of a punch device;

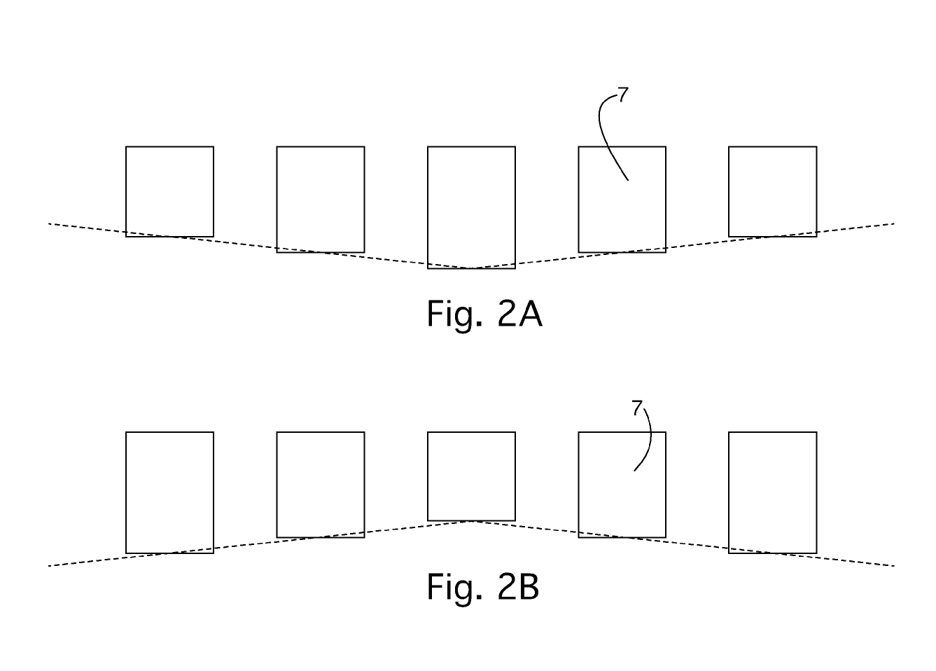

FIGS. 2A and 2B show schematic views of positioning of the punch elements;

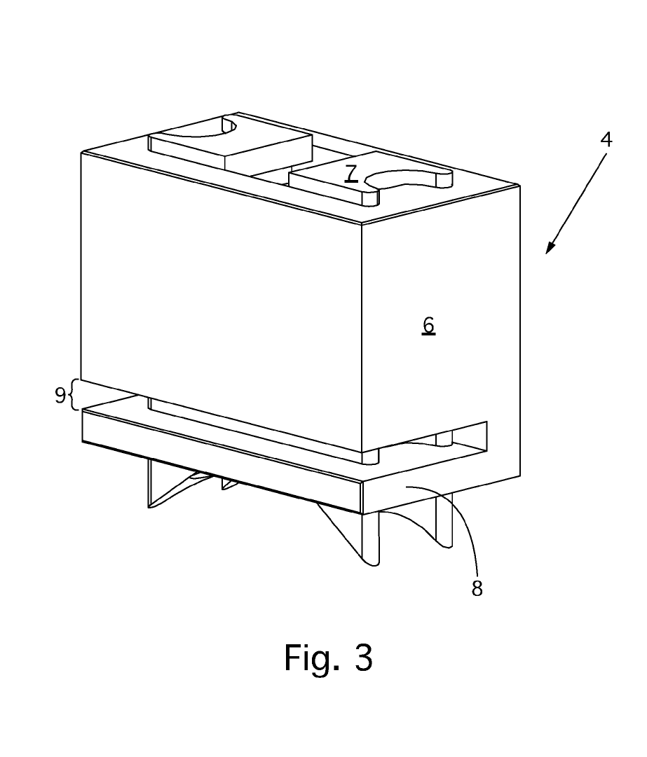

FIG. 3 shows an embodiment of a punch assembly;

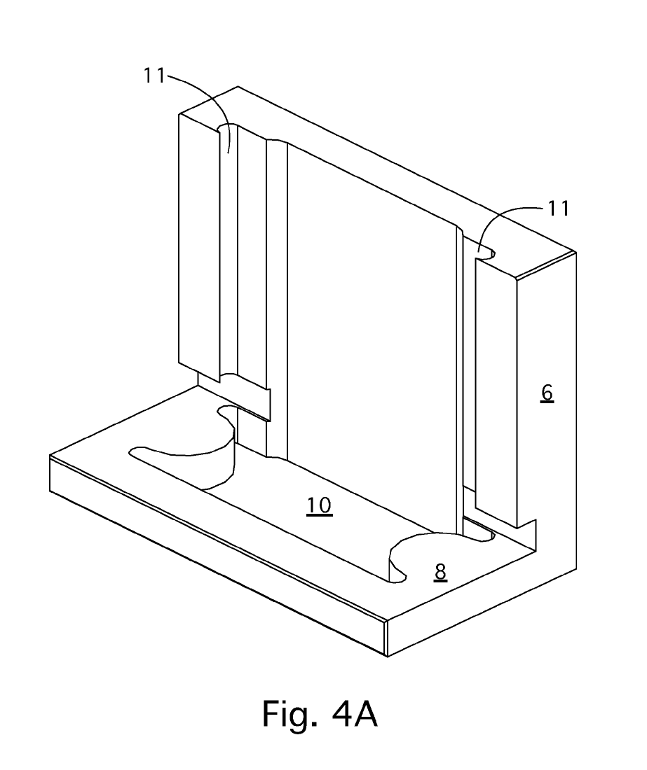

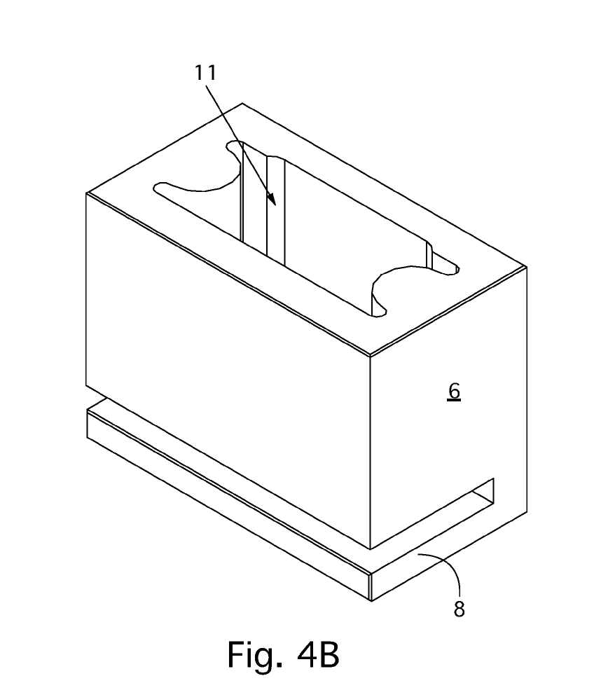

FIGS. 4A and 4B show embodiments of a housing of a punch assembly;

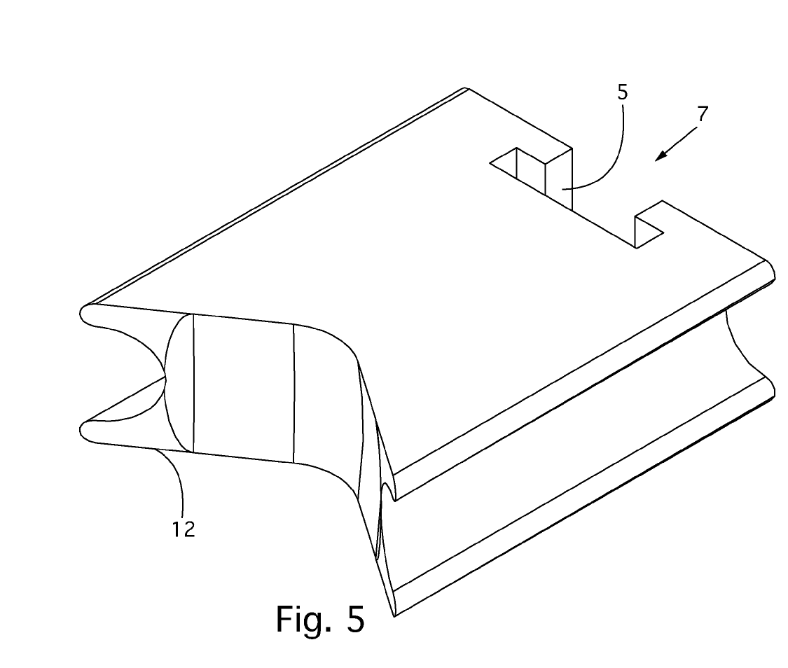

FIG. 5 shows an embodiment of a punch blade;

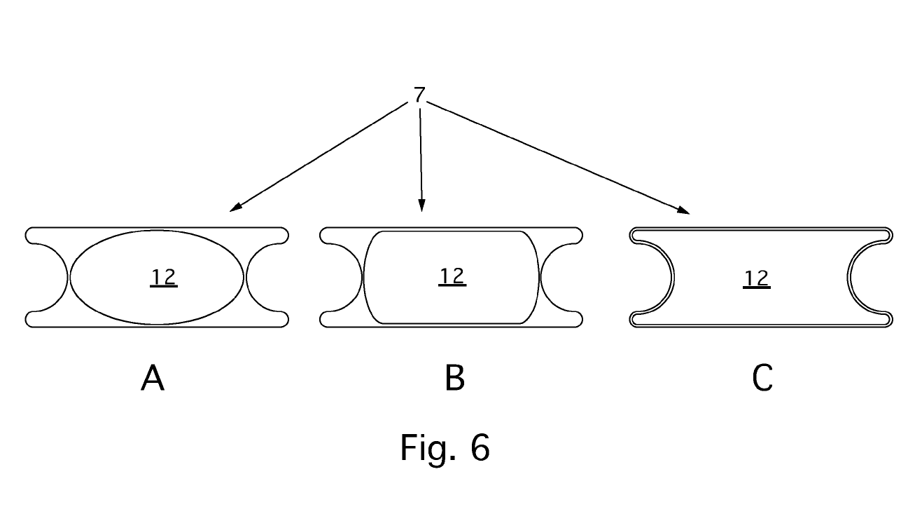

FIG. 6 shows cross-sections of embodiments of a punch blade; and

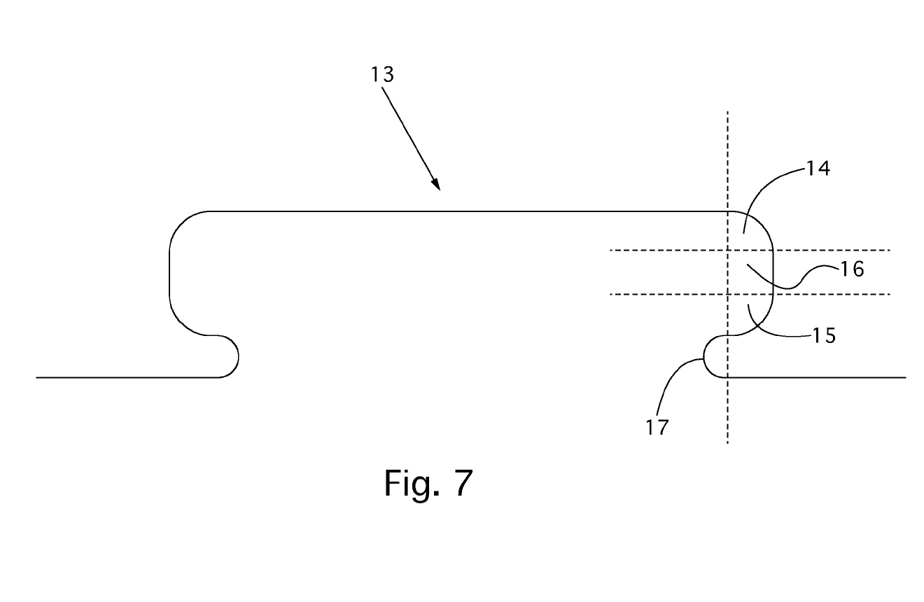

FIG. 7 is a schematic view of a tab of a sheet of paper.

FIG. 1 shows a punch device 1, wherein several components of punch device 1 are not shown in order to increase the clarity of the figure. Punch device 1 comprises an operating handle 2 which has the function of operating the punch device 1. Operating handle 2 is coupled to a frame 3. Operating handle 2 is also connected to a number of punch assemblies 4. Punch assemblies 4 are coupled to frame 3 via mounting means 5. Each of the punch assemblies 4 further comprises a housing 6 in which a punch blade 7 is arranged. Punch blade 7 is movable relative to housing 6. Housing 6 is described in more detail below. Shown in this figure is that the mounting means 5 are provided on punch blade 7, although mounting means 5 can equally well be provided on housing 6 of punch assembly 4. When operating handle 2 is moved in the direction of arrow A, the punch blades will move substantially in the same direction in order to punch paper.

FIGS. 2A and 2B show a possible positioning of punch blades 7 relative to each other. It can clearly be seen that punch blades 7 are positioned in a V-shape or reverse V-shape. An advantage hereof is that the force exerted by a user on operating handle 2 is not divided equally over all punch blades 7, but that this force is distributed gradually. This is realized in that the punch blades 7 make successive contact with a sheet of paper for punching as a result of the V-shape or reverse V-shape. A user need therefore exert less force on the whole unit, this enhancing the lifespan of punch device 1.

FIG. 3 is a schematic view of an embodiment of a punch assembly 4. Shown clearly in this view is that punch blade 7 is largely enclosed by housing 6, so that punch blade 7 is shielded from outside influences. Housing 6 fits closely adjacent to punch blade 7 so that there is limited play between punch blade 7 and housing 6. Play can after all result in an inclining orientation of punch blade 7, which can itself result in damage to punch blade 7. Housing 6 is further provided with a punch plate element 8 which serves to support a sheet of paper during punching thereof. A sheet of paper is inserted into opening 9, whereby an alignment of the sheet of paper is also effected. Also shown is that punch blade 7 moves through punch plate element 8, and this results in the above stated advantages caused by the shear force.

FIG. 4A is a first schematic view of a housing 6 of a punch assembly according to the invention. Housing 6 likewise comprises a punch plate element 8 in which a recess 10 is provided for at least partially receiving a punch blade 7. Further provided on housing 6 is a guide 11 for guiding the punch blade 7. In this embodiment housing 6 fits closely adjacent to one side of punch blade 7.

FIG. 4B is a further schematic view of another housing 6 of the punch assembly. In contrast to FIG. 4A, housing 6 fits closely all around punch blade 7 in this embodiment. The recess 11, in which the punch blade is placed during use, also serves here as guide 11.

FIG. 5 is a schematic view of a punch blade 7 according to the invention. Shown is that in this embodiment the punch blade is provided with mounting means 5 so that a coupling to frame 3 of punch device 1 is possible. A cutting face 12 is further provided on an outer end of punch blade 7.

The punch blade has a curvature from a higher point in the centre to a lower front side and a lower rear side as well as a curvature from the higher point in the centre to a lower left side and a lower right side. During cutting the tips hereby make first contact with the paper for cutting. The paper is hereby fixed by the tips of the blade, whereby it becomes possible to cut out the wide tabs. In other words, the blade with such a form in this way provides a very surprising effect enabling the tabs to be cut away over substantially half the width. The side edges and front and rear cutting faces likewise have a curved line, wherein the tips of the blade are the lowest points and come into engagement first with the paper. The lower surface of the blade body is preferably also higher than the cutting faces. All these measures are shown in the filed figures by means of curvature-indicating auxiliary lines on the surface of the underside of the blade. Such measures, such as a double-curved bottom surface of the blade, are not necessary, for instance for the paper fixation, in the case of small punch devices or for instance when punching at a distance from the edges of paper.

FIG. 6 shows different cross sections a,b,c of a punch blade 7 according to the invention. The hollow space 12 of punch blade 7 affects the sharpness of the cutting face of punch blade 7. The sharpness of the cutting face influences the quality of punching. It is possible to envisage determined areas/transitions between areas being more difficult to punch than for instance straight lines, whereby a sharper cutting face is required for the more difficult areas than for instance for the straight lines. The strength of punch blade 7 is also influenced in this way.

FIG. 7 is a schematic view of a tab 13 of a sheet of paper 18. A cheek of tab 13 here has a shape made up of two quarters 14, 15 of a circle with a straight line segment 16 therebetween. The transition 17 between a surface 18 of the sheet of paper and the tab 13 takes the form here of a semicircle, although this shape can be the same as the shape of the cheek. Another possible shape is an oval shape. The advantages of said shapes have been described above.

The present invention has been described in the foregoing on the basis of several preferred embodiments. Different aspects of different embodiments are deemed described in combination with each other, wherein all combinations which can be deemed by a skilled person in the field as falling within the scope of the invention on the basis of reading of this document are included. These preferred embodiments are not limitative for the scope of protection of this document. The rights sought are defined in the appended claims.

1. A punch device for punching a stack comprising at least one sheet of paper, the punch device comprising:
a frame;
at least one guide element for guiding the stack to a punching position;
at least one punch element for co-action with a respective punch plate element and which is mounted movably on the frame, wherein the punch element is movable reciprocally from a rest position along a punching path; and
an operating element for moving the punch element selectively along the punching path,
wherein the punch device is adapted to punch at least one recess in an cutting face of the stack.

2. The punch device as claimed in claim 1, wherein a second guide element is provided on the frame which is preferably located a distance from the guide element such that the stack is movable between the guide element and the second guide element.

3. The punch device as claimed in claim 1, wherein more than one punch element is mounted on the frame.

4. The punch device as claimed in claim 3, wherein the punch elements are movable simultaneously between the rest position and the punching position.

5. The punch device as claimed in claim 1, wherein, when the punch elements are in the rest position, undersides of the punch elements form substantially a V-shape or reverse V-shape.

6. The punch device as claimed in claim 1, wherein the punch element is a punch blade for punching the stack, the punch blade comprising:
an elongate body with a peripheral form corresponding to a desired form of a recess to be punched, wherein at least one outer end of the elongate body is sharpened for the purpose of punching the stack.

7. The punch device as claimed in claim 6, wherein the elongate body is at least partially hollow.

8. The punch device as claimed in claim 6, wherein the punch blade is completely hollow in a cutting face thereof or comprises a rectangular or oval recess.

9. The punch device as claimed in claim 1, wherein at least one side of the punch element has a shape selected from the group comprising: a semicircular shape, an oval shape, and/or a shape comprising a straight line segment preferably having two quarters of a circle added thereto.

10. The punch device as claimed in claim 9, wherein an opposite side has a similar shape to the at least one side.

11. The punch device as claimed in claim 1, wherein the punch element co-acts with a guide housing, wherein the punch element and the guide housing form a punch assembly.

12. The punch device as claimed in claim 11, wherein the guide housing comprises:
a punch plate element adapted to support the stack during a punching operation; and
a guide for guiding the punch blade, wherein the guide is arranged on the punch plate element substantially transversely of the punch plate element.

13. The punch device as claimed in claim 12, wherein the guide at least partially encloses the punch element.

14. The punch device as claimed in claim 1, wherein a passage for the punch element is provided in the punch plate element.

15. The punch device as claimed in claim 1, wherein the punch element and/or the punch assembly are mounted releasably on the frame.

16. A punch blade as claimed in claim 6.

17. A punch assembly as claimed in claim 1, comprising mounting means for arrangement thereof in a punch device.

18. A sheet of paper produced with the use of a punch device as claimed in claim 1.

19. The sheet of paper as claimed in claim 18, wherein the sheet of paper comprises tabs on at least one cutting face of the sheet of paper, which tabs each comprise at least one cheek and/or at least one flange.

20. The sheet of paper as claimed in claim 18, wherein a shape of the at least one cheek and/or flange is selected from the group comprising: a semicircular shape, an oval shape, and/or a shape comprising a straight line segment preferably having two quarters of a circle added thereto.

21. A method for producing a sheet of paper as claimed in claim 18, the method comprising steps for:
providing at least one sheet of paper;
placing the at least one sheet of paper against a guide element;
guiding the at least one sheet of paper to a punching position;
punching at least one recess into an cutting face of the sheet of paper; and
taking the sheet of paper out of the guide element.
